(19) United States
(12) Patent Application Publication
(10) Pub. No.: US 2021/0325867 A1
(43) Pub. Date: Oct. 21, 2021

(54) MOBILE COMMAND AND CONTROL SYSTEM FOR UNMANNED AERIAL VEHICLES

(71) Applicant: EAST WEST RESOURCES CORPORATION, Rockville, MD (US)

(72) Inventors: Scott PALAZZOLA, Concord, CA (US); Benjamin GARRISON, Bethesda, MD (US); Gomerjohn HOLGADO, Concord, CA (US)

(73) Assignee: E-N-G MOBILE SYSTEMS, LLC, Concord, CA (US)

(21) Appl. No.: 17/206,439

(22) Filed: Mar. 19, 2021

Related U.S. Application Data
(60) Provisional application No. 63/011,600, filed on Apr. 17, 2020.

(51) Int. Cl. G05D 1/00; H04W 88/06; B64C 39/02

(52) U.S. Cl. CPC G05D 1/0022; H04W 88/06; B64C 2201/146; B64C 2201/027; B64C 39/024

(57) ABSTRACT

Mobile command control systems for unmanned aerial vehicles (UAVs) are described herein. In one aspect, a system for controlling an UAV can include a mobile vehicle including at least a vehicle chassis; a telescoping mast including a proximate end and a distal end, the proximate end coupled to a center portion of the mobile vehicle chassis; and a plurality of antenna arrays coupled to the distal end of the telescoping mast, each of the antenna arrays having either different radio access technologies (RATs), different operating frequencies, or a combination thereof.

### CROSS REFERENCE TO RELATED APPLICATIONS

This application claims the priority of provisional application 63/011,600, having a Filing Date of Apr. 17, 2020, the entire contents of which are hereby incorporated in total by reference.

### BACKGROUND OF THE INVENTION

In recent years, the number of unmanned aerial vehicle (UAV) operations being conducted for both private use and enterprise applications have expanded exponentially. In that time, the Federal Aviation Administration (FAA) and the National Transportation Safety Board (NTSB) have worked diligently to safely integrate UAVs into the national airspace system (NAS).

However, many of the commercially available systems for controlling and operating an unmanned aerial system (UAS) are limited in their functionality to safely and effectively conduct flight operations for the purpose of identifying, measuring, and quantifying airborne hazardous materials (HAZMAT). Effective first response to an incident involving HAZMAT is critical to minimizing the long-term impacts of incidents in terms of public health, responder safety, and environmental degradation.

As an example, in August of 2017 Hurricane Harvey, a category 4 hurricane, made land fall in Texas and Louisiana. Among the impacts of this devastating storm were catastrophic rainfall-triggered flooding. Due to Harvey's storm surge, it is estimated that between 2.2 million and 4.6 million pounds of airborne emissions (exceeding state limits) were released from 46 facilities across 13 counties. Included in the releases were pollutants such as benzene, butadiene, and other petroleum-based compounds. These chemical compounds are also referred to as Toxic Inhalation Hazards (TIH) or Poison Inhalation Hazards (PIH) in the Emergency Response Guidebook. Most of the air monitoring in this specific case was conducted through high altitude flyovers which were conducted days and weeks after the storm. Additionally, ground-based sensors were not operational immediately following the storms landfall due to flooding. Exacerbating the issues of response and communication coordination among first responders was the fact that wireless networks along the Texas coast suffered outages as a result of the Hurricane. The confluence of events left residents and responders without actionable intelligence during the most critical time period immediately after the storm's landfall.

What these counties and first responders were lacking was a system to safely: conduct low-altitude and site-specific readings of airborne HAZMAT, visual reconnaissance of suspected incident sites, and transmit both streams of data to an incident command system.

### SUMMARY

Mobile command control systems for unmanned aerial vehicles (UAVs) are described herein. In one aspect, a system for controlling an UAV can include a mobile vehicle including at least a vehicle chassis; a telescoping mast including a proximate end and a distal end, the proximate end coupled to a center portion of the mobile vehicle chassis; and a plurality of antenna arrays coupled to the distal end of the telescoping mast, each of the antenna arrays having either different radio access technologies (RATs), different operating frequencies, or a combination thereof.

This aspect can include a variety of embodiments. In one embodiment, the telescoping mast can extend to include a distance between the distal end and the proximate end of at least 50 feet.

In another embodiment, the mobile vehicle can further include a vehicle shell defining an occupancy cavity, where the proximate end passes through the occupancy cavity to couple to the mobile vehicle chassis.

In another embodiment, the plurality of antenna arrays can include a 2.4 GHz radio antenna array, a 900 MHz radio antenna array, and a very high frequency (VHF) air-band antenna array.

In another embodiment, the system can further include the UAV, where the UAV communicates with the mobile vehicle via at least one antenna array of the plurality of antenna arrays of the telescoping mast. In some cases, the mobile vehicle is in further communication with an air traffic control (ATC) station via at least another antenna array of the plurality of antenna arrays of the telescoping mast.

In some cases, the UAV is a HAZMAT UAV, where the HAZMAT UAV includes gaseous sensory capabilities, sensor data transmission capabilities, a waterproof airframe, a dustproof airframe, or a combination thereof. In some cases, the communication range between the UAV and the mobile vehicle is up to 40 miles.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts a mobile command and control system for controlling and operating unmanned aerial vehicles (UAVs), according to an embodiment of the present disclosure.

FIG. 2 depicts a transmission mast for controlling and operating UAVs, according to an embodiment of the present disclosure.

FIG. 3 depicts a floor plan of a mobile command and control system, according to an embodiment of the present disclosure.

FIG. 4 depicts an environment for controlling and operating UAVs, according to embodiment of the present disclosure.

FIG. 5 depicts an unmanned aerial system (UAS) Traffic Management (UTM) Conflict Management model as described in “UAS Service Suppliers Development of Specifications, Tests, and Implementations in Parallel.” Presentation. UAS Traffic Management (UTM) Project, National Aeronautics and Space Administration, Sep. 19, 2019.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

Described herein is a mobile command and control (C2) system and associated methods for controlling and operating specialized unmanned aerial vehicles. The mobile C2 system can be implemented in a variety of applications, including emergency response, environmental monitoring, airborne HAZMAT inspection or monitoring, etc. Additionally, the below disclosure describes how the mobile C2 system effectively conducts these applications in flight profiles that include beyond visual line of sight (BVLOS), operations from a moving vehicle, operations in controlled airspace, etc.

The ability for commercial operators to conduct unmanned aerial system (UAS) operations of multiple aircraft, beyond visual line of sight, and from a mobile control station greatly improves the economics and feasibility of many commercial applications described above. The mobile C2 system described herein can:
meet and/or exceed the range and reliability of commonly used available control linkages from the aircraft to a remote-control station;
provide redundant power sources to protect from lost linkages;
increase efficiency of the operation by controlling aircraft in rugged terrain not accessible on foot or due to right of way issues;
shelter pilots from undesirable elements and extreme weather events such as thunderstorms, tornadoes, and hurricanes and excessive heat or cold;
protect pilots from the potential exposure that may occur in the course of an emergency response operation to airborne HAZMAT or CBRN events; and/or
improve the flow of information from the C2 system to various stakeholders and incident commanders such as federal, regional, and local emergency response entities.

With the stability and payload capacity of a vehicle-based and mast-mounted communication system, the C2 system can extend the range and reliability of RF-based communication links and data processing from the UAV and corresponding onboard sensors. Additional hardware can provide a redundant supply of electrical systems that power these necessary links. The C2 system can also improve the efficiency and economics of operating drones reliably from a mobile command and control platform in a number of ways, for example, by extending the flight range of drone operations by reducing the distance of the return flight and conserving fuel sources.

The C2 system can also improve the capability and reliability of drone flight control by addressing important issues of national airspace integration while providing:
standoff monitoring and detection of airborne HAZMAT found in industrial and petro-chemical infrastructure;
emergency response and incident command of airborne HAZMAT events caused by leakage, mechanical failure, industrial accidents, natural disasters, malicious intent, etc.; and
inspection or surveillance of large areas with high security concerns, such as coastal ports, airports, military bases, etc.
   Thus, the unique integration of existing and new technologies within the C2 system improves the performance of these systems and allows pilots/operators the ability to conduct flight operations at a protective distance from toxic airborne releases. Further, it provides the ability to gather site specific and low-altitude sensor readings, combined with a process for transmitting the UAS based video and sensor data to authorities that will enhance real-time decision making. This critical data can improve public and responder safety.

A unique feature of the C2 systems described in the present disclosure is a commercially available, heavy-duty pneumatic driven and telescoping mast. The integrated mast of the vehicle can reach a height of 50 feet when fully extended and is rated for a maximum payload capacity of 300 pounds. The mast can be combined with a custom designed mounting platform suitable to support an array of UAS communications equipment. The extended height and available payload of the heavy-duty mast and mast platform, combined with multiple sources of AC/DC power from the vehicle, can provide a superior level of RF signal strength to airborne devices through MIMO radios and high-gain antennae. Further, the collection of integrated hardware can serve several functions including: the primary and secondary means of UAV flight control, UAV telemetry, sensor data, video feeds.

Additional mast mounted equipment can include a dual sensor PTZ camera, which can facilitate the visual referencing and tracking of the UAV while also improving the separation of the UAV from other manned and unmanned aircraft in the area of operation. Video feed from the PTZ camera can be relayed to screens in the C2 vehicle, where pilots/operators of the UAV can rely on the feed to visualize the UAV and other objects within range of the PTZ camera. In some cases, the video feed can be processed prior to being visualized on a screen. For example, a processor can detect and identify objects in view (the UAV, other aerial objects, etc.). and can determine various metrics associated with the detected objects (e.g., distance away from the C2 vehicle, distance between different viewed objects, travelling speed, etc.). The processor can further enhance the video feed prior to visualization, for example by highlighting detected objects and inlaying determined metrics with the video feed.

Secondary transmitters/receivers and antennae on the mast can be incorporated to provide communications links between the C2 vehicle operators and air traffic control (e.g., via VHF air-band) as well as public agencies (e.g., via UHF radios). These additional communication links can facilitate the safe operation and coordination with ATC and incident commanders.

Wireless and cellular networks can be utilized when available to incorporate aviation related decision-making information from UAS Service Suppliers and Supplemental Data Service providers. Availability of broadband connectivity can facilitate data transmission from the C2 vehicle to end users via cloud-based applications. A content application programming interface (API) provide interaction between the various streams of data from airborne systems and software to produce a customized dashboard of actionable intelligence for authorities.

Specialty long-range UAVs can be equipped with 2×2 MIMO transceiver radios and linked to a matching 2×2 MIMO transceivers integrated in the C2 vehicle's mast. An infrared camera can also be mounted to the UAV, which can provide intensity measurements to a radiometric thermal camera. The radiometric thermal camera can then determine the temperature of a surface by interpreting the intensity of an infrared signal. For example, the radiometric thermal camera can be calibrated to correlate a temperature with a certain level of radiation intensity within the spectral band of 3.2 μm-3.4 μm. Image and/or video content captured by the system can be stored on an internal micro-storage device and transmitted via the same independent RF system to the C2 vehicle.

The C2 vehicle can receive additional metrics measured or monitored by the UAV, for example, chemical and radiation data measured or monitored by the UAV. In other examples, the C2 vehicle can receive data corresponding to GPS coordinates, electro-chemical data, non-dispersive infrared data, photo-ionization data, and radiation data. Measured data can be received by the C2 vehicle via an RF signal and can additionally output information to a designated computer for further analysis and transmission. Detectable compounds can include: Carbon Dioxide, Carbon Monoxide, Chlorine, Hydrogen, Hydrogen Chloride, Hydrogen Cyanide, Phosphine, Hydrogen Sulfide, Organic solvents, Methane, Nitric Oxide, Nitrogen Dioxide, Nitrous Oxide, Oxygen, VOCs, Sulfur Dioxide, Formaldehyde, Particulates, Non-methane Hydrocarbon, T R S and Amines, Ammonia, Ozone, Radiation, Chlorine Dioxide, and the like.

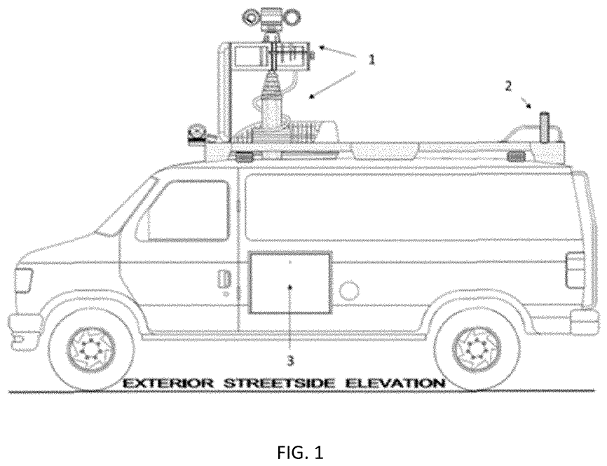

FIG. 1 illustrates a mobile command and control system 100 for controlling and operating unmanned aerial vehicles (UAVs), according to an embodiment of the present disclosure. The command and control system 100 can include a transmission mast 1, a surveillance-broadcast receiver 2, and a redundant power source 3. In some cases, the mobile command and control system can be integrated into a motor vehicle, such as a car or van (e.g., as shown in FIG. 1). However, the system can be integrated into a variety of mobile applications, such as a remote-controlled vehicle, an aerial vehicle, a water vehicle, etc.

The transmission mast 1 can increase the transmission range of the system 100 to communicate with various UAVs. For example, the transmission mast 1 can be extended to a height of up to 50 feet above the mounting platform used to connect the transmission mast 1 to the vehicle. The height of the transmission mast 1 can be controlled to be between the height of the platform and the maximum height (e.g., between 0 feet and 50 feet, etc.). The transmission mast can also be rotatable along the plane of the mounting surface. For example, the transmission mast 1 can be rotatable by 15 degrees, 30 degrees, 45 degrees, 60 degrees, 75 degrees, 90 degrees, 105 degrees, 120 degrees, 135 degrees, 150 degrees, 165 degrees, 180 degrees, etc.

There are five main factors that limit the range of RF devices in their applications: power as expressed in watts (W) or decibel-milliwatts (dBm), frequency, antenna/cable selection, antenna height, and ground interference. Through integration and design, the C2 system described herein reduces the impacts of radio path loss and thereby improves the range, reliability, and throughput of the UAS. These improvements are designed in order to meet the apparent needs of responders engaged in emergency response, detection and inspection environments.

For example, conventional UAV systems are operated by cellular devices or RC controllers. These conventional systems employ single omni-directional antenna transceivers (e.g., operated at ground level), have power outputs ≤26 dBm, antenna gains ≤2 dBi, and are powered by rechargeable batteries. As a result, the typical range of these devices in perfect conditions typically do not exceed 4 km. The ability of conventional UAV systems to transmit live video and additional sensor data is further limited by the reliance on cellular networks and the amount of throughput resulting in an average range of 1-2 km. Operating conditions at low altitudes and in suburban, urban, and densely populated environments where first responders commonly operate can further reduce RF signal strength.

This transmission mast 1 reduces the impact of the limiting factors listed above and thereby improves the range and reliability of the drone. For example, at 5 miles, a 2.4 GHz radio requires a height of 31 feet to reach 60% clearance of the Fresnel Zone, and a 900 MHz radio would require 50 feet antenna height to also achieve a 60% clearance. The system 100 utilizes both frequencies for redundancy and possesses the ability to achieve more than a 60% clearance of the Fresnel Zone in the 2.4 GHz band. Therefore, one critical function of the transmission mast 1 is to obtain the greatest clearance from the Fresnel zone and to achieve greater RF range, and therefore control linkage, compared to conventional UAV command and control systems operated at ground level and commonly used in the industry today.

Various radio access technologies (RATs) can be mounted to the top of the transmission mast 1. A control transceiver for use in controlling a UAV can be attached to the top of the transmission 1. The control transceiver can operate, for example, in the 2.4 GHz frequency range. Additionally, a long-range antenna can be mounted to the top of the transmission mast 1 and can communicate with on-site hardware (e.g., a central headquarters). In some cases, the different RATs can share antennas for communications, e.g., under a coordinated antenna sharing protocol. In some cases, interference control protocols can be implemented to mitigate potential interference issues between different antennas mounted to the top of the transmission mast 1 (e.g., co-channel interference mitigation, adjacent channel interference mitigation, intersymbol interference, mitigation inter-carrier, interference mitigation, and the like).

In some cases, an air band transceiver can also be mounted to the top of the transmission mast 1 for communicating with other air traffic (e.g., local air traffic control). It is important to note that the situational awareness of pilots operating within the NAS and around the airport environment is critical to the safe commercial use of UAS. As shown, the separation of unmanned and manned aircraft is a primary concern of the FAA. An important part of this separation begins in receiving very high frequency (VHF) radio transmissions used by air traffic control entities and also broadcasting on common traffic advisory radio frequencies. These radio transmissions are a critical component to reduce potential airspace and traffic conflicts in real time before they arise.

Additionally or alternatively, the transmission mast 1 can also include an imaging system, such as a camera. The imaging system can detect, recognize, and identify objects or environments, such as a controlled UAV or an emergency situation. The imaging system can capture and relay images back to the corresponding vehicle to which the system 100 is mounted to an off-site location (e.g., a central headquarters), or both. Further, the imaging system can utilize any one of the RATs of the transmission mast 1 discussed above, or can include an integrated RAT for communication.

An automatic dependent surveillance-broadcast (ADS-B) receiver 2 can also be mounted to the vehicle. The ADS-B receiver 2 can receive surveillance-broadcast communications from other aerial vehicles. The surveillance-broadcast communications can provide identity and positioning location of the transmitting aerial vehicle. As such, the ADS-B receiver 2 can receive these communications for detection/identification purposes (e.g., air traffic control, etc.).

The power source 3 can be mounted on, or located within, the vehicle of the system 100. The power source 3, which can be a generator, an inverter, an auxiliary battery, or a combination thereof, can provide power or redundant power for the transmission mast 1, the surveillance-broadcast receiver 2, or both. The power source 3 can also in some cases power additional electronics installed in the vehicle, such as displays, processors, and/or memory for relaying information from the transmission mast 1 and/or the surveillance-broadcast receiver 2 to users of the vehicle or off-site (e.g., a central headquarters).

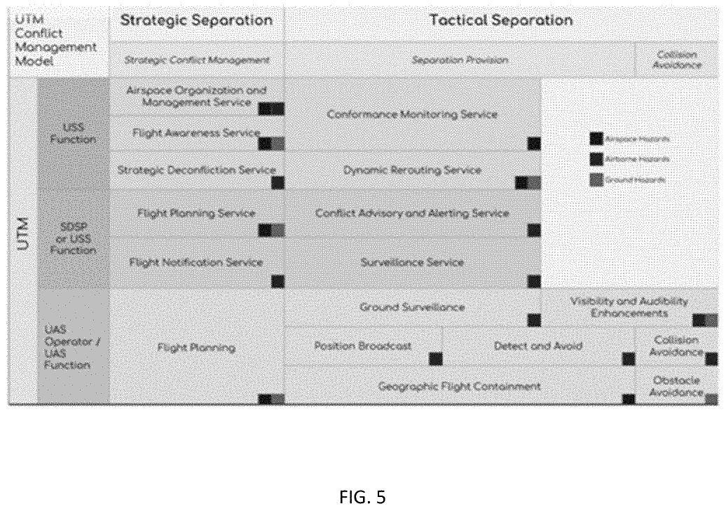

The system 100 can also provide a variety of services. The command and control system can include a subscription-based system, which provides real-time access to radar feeds, radar data plans, and interactive software apps. This will provide pilots/operators with a real-time display of aircraft in the airspace surrounding the area of operation and displayed in the internal cockpit 23 alongside its ADS-B counterpart. Although not required by federal regulations, this system can address some federal concerns (e.g., FAA Rulemaking Issues 1 and 5, and concerns of integration as defined in the UTM Conflict Management Model of FIG. 5).

The system 100 can also provide LAANC services (e.g., via a subscription-based service). LAANC can be operated through the UAS Data Exchange and facilitates the sharing of airspace data between the FAA and companies approved by the FAA to provide LAANC services. The companies are known as UAS Service Suppliers—and the desktop applications and mobile apps to utilize the LAANC capability are provided by the UAS Service Suppliers (USS). LAANC automates the application and approval process for airspace authorizations. Through automated applications developed by an FAA Approved UAS Service Suppliers (USS) pilots apply for an airspace authorization. Although a voluntary system, ready access and use of the LAANC system addresses FAA concerns of integration as defined in the UTM Conflict Management Model of FIG. 5.

For a UAV to be a truly effective tool in the application of detecting, inspecting, and responding to airborne HAZMAT events, the UAV and its supporting systems must share certain characteristics. As such, UAVs 26 operating in conjunction with the command and control system have been uniquely designed and built to meet the objectives of these mission profiles and adapted to suit a variety of conditions. First and foremost, the aircraft can be operationally versatile, more affordable and safer to operate than other aerial methods, namely manned rotary and fixed-wing aircraft as well as satellites. The UAV power plant, a hybrid/Gas electric engine and its airframe, and a vertical take-off and lift (VTOL) multi-rotor can be used to optimize these applications. The UAV 26 can operate at lower speeds and can be sensitive to chemical and radiation sensors that are less susceptible to motion, wind and thermal turbulence. Further, the UAV 26 can operate under the longest possible flight times and payload capabilities, yet still remain compliant with federal regulations.

The UAV 26 can be powered by a Hybrid Gas/Electric engine and can exceed both the flight times and payload capabilities of battery powered counterparts that are readily available off the shelf. The UAV 26 can include superior repetitive launch and recover cycle capabilities compared to commonly used battery powered UAVs which require long charging cycles and an excess of battery inventory. This decreases downtimes and enhances the economic feasibility of the operation. Further, the UAV 26 can operate at lower continuous altitudes (e.g., below cloud level) than its fixed-wing counterparts commonly available. The UAV 26 and its related supporting systems can be capable of information fusion and sharing, in other words providing a bridge between different information technologies.

### Benefits Provided by C2 System

1. The C2 system disclosed herein provides an improvement in the RF line-of-sight transmission capabilities used for UAV control in terms of Fresnel zone clearance. This can be achieved by reducing obstacle clearance and ground interference through antenna height. The general rule of thumb is that the 1st Fresnel zone must be 60% clear of obstruction from the center line of sight to the outer boundary of the 1st Fresnel zone to maintain a good connection. For example, at 5 miles, a 2400 MHz radio transmission requires an antenna height of 31 feet to reach 60% clearance of the Fresnel Zone, and a 900 MHz radio would require a 50 feet antenna height to also achieve a 60% clearance. Both 900 Mhz and 2400 MHz frequency bands are commonly used in commercial UAS. The C2 mast and mast platform can be integrated to obtain the 60% Fresnel zone clearance of both frequency bands and therefore achieve greater RF signal strength and control linkage for long-range UAV operation, particularly when compared to conventional control systems operated at ground level.

2. The integration of the C2 system allows it to take advantage of the Maximum (EIRP) for unlicensed wireless equipment as mandated by the FCC. EIRP is a measure of radiated power in terms of output power (dBm), cable loss (dB), and antenna gain (dBi). In other words, EIRP is the combination of the power emitted by the transmitter and the ability of the antenna to direct that power in a specific direction. Based on the formula:

EIRP=Pₜ−L_{c}+Gₐ

EIRP is important as a measure of signal strength and signal coverage that the UAV can be operated at within the confines of established regulations. The mast's available payload and height provides the capability to mount large high-gain directional antenna. Further, the system's multiple electrical sources (generator, inverter/charger, shore power, etc.) can provide a constant and redundant supply of AC/DC power to RF transmitters. As a result, the C2 system platform can generate and maintain the maximum allowed EIRP (e.g., 36 dBm) compared to common EIRP abilities of commonly used in commercial UAS ground control stations (e.g., 26 dBm).

3. The C2 system can also provide an improvement in Free Space Path Loss (calculated as the loss in dB between two antennas), which can be used to predict antenna strength. As an example, based on the formula below, the C2 system has a reduced FSPL of 90.04 dB compared to 116 dB of a conventional control system.

FSPL=20 log₁₀(d)+20 log₁₀(f)+20 log₁₀(4π/c)−Gₜ−Gᵣ

| ARS/ENG C2 System | | Standard GCS | |
|---|---|---|---|
| Distance (km) | 10 | Distance (km) | 10 |
| Frequency (MHz) | 2400 | Frequency (MHz) | 2400 |
| Transmitter Gain (dB) | 15 | Transmitter Gain (dB) | 2 |
| Receiver Gain (dB) | 15 | Receiver Gain (dB) | 2 |
| Free Space Path Loss (dB) | 90.04 | Free Space Path Loss (dB) | 116 |

4. The C2 system also experiences an improvement in Received Power (measured in dBm), which is commonly used to determine signal strength considering output power, gain, and free space path loss. It assumed that no losses are experienced on the RX/TX side due to lack of information, in the example provided below. Received Power can be determined based on the formula provided below:

Pₒᵤₜ−Pₜ+Gₜ−Lₜ−L_{fs}−Lₘ+Gᵣ−Lᵣ

Due to the low power levels and the attenuation of free space, the received power value is expressed as a negative number. Therefore, the more negative the number, the weaker the signal strength. Conversely, the closer the number is to zero, the stronger the signal. As the table below shows, the signal strength of the C2 system is greater compared to a conventional control system.

| ARS/ENG C2 System | | Standard GCS | |
|---|---|---|---|
| Transmitter Power Output | 21 | Transmitter Power Output | 26 |
| (dBm) | | (dBm) | |
| Transmitter Gain (dB) | 15 | Transmitter Gain (dB) | 2 |
| Transmitter Loss (dB) | 0 | Transmitter Loss (dB) | 0 |
| Free Space Path Loss (dB) | 90.04 | Free Space Path Loss (dB) | 116 |
| Receiver Gain (dB) | 15 | Receiver Gain (dB) | 2 |
| Receiver Loss (dB) | 0 | Receiver Loss (dB) | 0 |
| Received Power (dBm) | −39.04 | Received Power (dBm) | −86 |

5. The C2 system can also improve lie of sight distance and service range. Considering the benefit of the added TX/RX antenna height, line of sight distance and radio horizon service range can be calculated given the formulae below.

dₜ=\sqrt{2Rh}≈3.57×\sqrt{h}

dᵣ=4.12×\sqrt{h}

| ARS/ENG C2 System | | Standard GCS | |
|---|---|---|---|
| Antenna Height (ft) | 50 | Antenna Height (ft) | 3 |
| Line of Sight Distance (km) | 13.94 | Line of Sight Distance (km) | 3.41 |
| Radio Horizon Service | 16.08 | Radio Horizon Service | 3.94 |
| Range (km) | | Range (km) | |

6. With the added benefit of MIMO technology, power output, antenna gain and antenna height, the enhanced operation of the C2 system can be compared to other available single-in, single-out (SISO) conventional control systems in terms of the expected signal strength for a given throughput.

In this model, it is assumed that both systems are operating on a 20 MHz bandwidth, with a required throughput of 20 Mbps (to maintain UAV telemetry and data transfer). The 2×2 MIMO based system integrated with the C2 vehicle is utilizing 2 spatial streams, and the Standard System is using 1 spatial stream. Further assumptions include: no cable loss (measured in db), no objects within 60% of Fresnel Zone, no bi-directional amplification, no cross-polarized antennas, and a safety margin of 5 db.

As a result, it can be seen in the tables below that for a given throughput of 20 Mbps of data transfer the C2 system can expect to maintain the required signal strength at a distance of 21.5 km compared to the conventional control system's distance of 2.1 km.

| ARS Mobile UAS C2 System | | Standard GCS | |
|---|---|---|---|
| Frequency (MHz) | 2400 | Frequency (MHz) | 2400 |
| Max TX power (dBm) | 21 | Max TX power (dBm) | 26 |
| TX antenna gain (dBi) | 15 | TX antenna gain (dBi) | 2 |
| Number of RX antennas | 2 | Number of RX antennas | 1 |
| RX antenna gain (dBi) | 15 | RX antenna gain (dBi) | 2 |
| TX antenna height (ft) | 50 | TX antenna height (ft) | 3 |
| RX antenna height (ft) | 50 | RX antenna height (ft) | 3 |
| EIRP (dBm) | 36 | EIRP (dBm) | 28 |
| Safety Margin (db) | 5 | Safety Margin (db) | 5 |
| Throughput (mbps) | 20 | Throughput (mbps) | 20 |
| Distance/Range for | 21.5 | Distance/Range for | 2.1 |
| 20 mbps throughput (km) | | 20 mbps throughput (km) | |

### Exemplary Embodiment

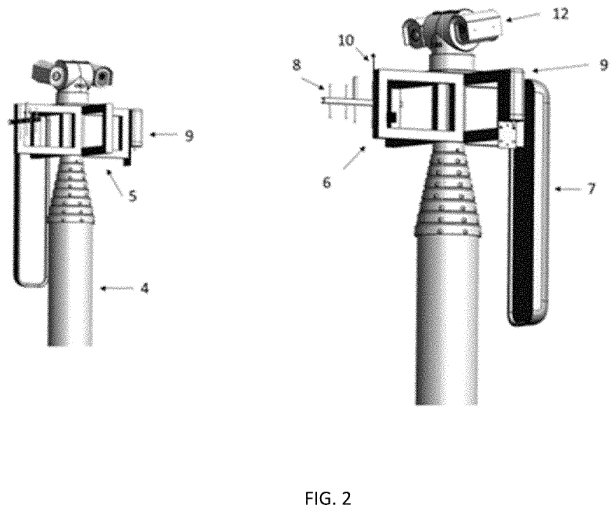

FIG. 2. illustrates an exemplary transmission mast configuration 200. The transmission mast configuration 200 can be implemented in conjunction with a mobile command and control system, such as system 100 as described in detail with reference to FIG. 1.

The transmission mast configuration 200 can include a telescoping mast 4. The telescoping mast 4 can be mechanically extendible and collapsible up to a predefined height (e.g., 50 feet). One end of the telescoping mast 4 (e.g., the proximate end) can be coupled to a middle portion (e.g., the center) of a vehicle chassis. The coupling can occur through different means, such as welding, bolting, etc.

The other end of the telescoping mast (e.g., the distal end) can be coupled to a mast platform 5. The mast platform 5 can provide a platform for attaching different antennas and other communication hardware to the telescoping mast 4. Examples of telecommunication hardware that can be installed on the mast platform 5 can include a 2.4 GHz radio 6, a 2.4 GHz 2×2 MIMO 90-degree sector slant L/R antenna 7, a 900 MHz long-range antenna 8, a 4G Omni antenna 9, a VHF air-band antenna 10, a multi-sensor PTZ camera 12, or a combination thereof.

The MIMO antenna can enhance the performance of UAS by transmitting several signals simultaneously through multiple antennas and still utilize a single channel. In urban environments, signal degradation between single antennas without clear line-of-sight can be problematic. Conversely, with a MIMO system, the same environment provides multiple reflection paths for signals to take between radios. Consequently, the C2 system of the present disclosure includes a higher total Effective Isotropic Radiated Power (EIRP) (e.g., 36 dBm), a directional antenna with high gain (e.g., 15 dBi), an antenna with high height (e.g., 50 ft), and continuous AC/DC power.

The communication mast configuration 200 can include a primary RF flight control antenna. Primary RF flight control of the UAV is made possible with the use of a 2.4 GHz (ISM) radio 6 utilizing a frequency range of 2400-2500 (MHz) and radio telemetry link encryption AES1286. The primary radio interface can connect to a 2×2 MIMO 90-degree sector slant L/R directional antenna 7 to provide precise and direct sectoral coverage. The transmission mast (e.g., mast 4) can be manipulated from the interior cockpit to rotate 45 degrees to either side of center to compensate for UAV heading changes while maintaining direct signal line of sight to the UAV. The auxiliary interface is wired into the vehicle and connected to a 150 w power over ethernet (POE) switch via an ethernet cable and an RJ45 port, which in turn outputs to a computer inside the command and control vehicle's cockpit which operates the flight/ground control software.

Additional RF equipment can include the 900 MHz long range antenna 8 and a 900 MHz RF modem with 256-bit AES encryption located within the command and control vehicle's interior cockpit. Utilizing a high gain antenna mounted on the vehicle's mast reduces interference and will provide greater line of sight ensuring the best possible range (e.g., 40 miles). The primary function of the 900 MHz system is to transmit data from the UAV-mounted HAZMAT sensor and is received by a designated computer through a DB-9 (RS232) serial connector. However, the 900 MHz transmitter can also provide a secondary means of flight control should the primary flight control system (e.g., the 2.4 GHz radio 6) fail. Having a secondary means of RF flight control addresses regulatory concerns of signal interruption to the UAV including “lost link” or signal jamming by a third party.

While terrain and obstructions will vary within each area of operation, a formula for calculating line of sight distances and radio horizon service ranges show a vast improvement in performance (reliability) of signal strength using the command and control mast mounted system:

dₗ=\sqrt{2Rh}≈3.57\sqrt{h}

dᵣ=4.12\sqrt{h}

Based on the formulas above, a conventional UAV flight controller with a handheld antenna height of 1 meter would yield a line of sight distance of 3.57 km and a radio horizon of 4.12 km. By increasing antenna height to 15.25 meters, line of sight distance increases to 13.95 km and radio horizon is improved to 16.1 km.

To address regulatory requirements related to communicating to air traffic control entities and to broadcasting on common traffic advisory radio frequencies, the command and control vehicle mast is equipped with a VHF air-band antenna 10 and the interior cockpit is equipped with a VHF air band transceiver 20 with a 9 w transmitter and frequency range of 118.000-136.99166 MHz.

As with the other integrated radio systems, VHF propagation is subject to line of sight and ground interference. By mounting this system on the command and control mast system the range (effectiveness and safety of operation) for air traffic control communications can be increased as well. Also powered by the same versatile electrical system of the power source (e.g., power source 3 of FIG. 1), the command and control system provides continuity of radio reception beyond the systems of most general aviation aircraft. Lastly, the ability to transmit on VHF air-band provides the user the capability to alert ATC or common air traffic in the area of operation of an emergency such as a “runaway” UAV caused by malfunction, lost link or jamming. This is especially critical when the area of operations are located within the vertical and lateral limits of controlled airspace.

Mounted on top of the transmission mast is a multi-sensor pan-tilt-zoom (PTZ) camera 12. This camera 12 is composed of an HD visible light camera for day use and a thermal infrared zoom and near-infrared (NIR) illumination with long range focus for night operation. The camera 12 utilizes a 39× optical 8-315 mm HD IR-corrected continuous zoom lens with a wide 41° angle through to a narrow 1.1° field-of-view. The camera 12 provides high resolution imaging in a wide range of light and weather environments from fog to complete darkness. IP66 weatherproof construction, gyro stabilized, and utilizes a serial RS485 connector to a controller located inside the vehicle cockpit allowing full PTZ operation. SDI video output from the camera is converted to HDMI operating on an ONVIF Profile S protocol designed to easily interface with a wide array of commercially available encoder/transmission solutions so that the imaging can be relayed back to an incident command structure in a remote location. The mast mounted video feed is also displayed on any of the internal cockpit monitors 21.

The camera 12 provides another layer of detection, recognition and identification of targets including the integrated UAV, other aircraft in the area of operation, and situational awareness of the incident or emergency operation. The addition of this equipment addresses regulatory concerns of integration as defined in the UTM Conflict Management Model illustrated in FIG. 5.

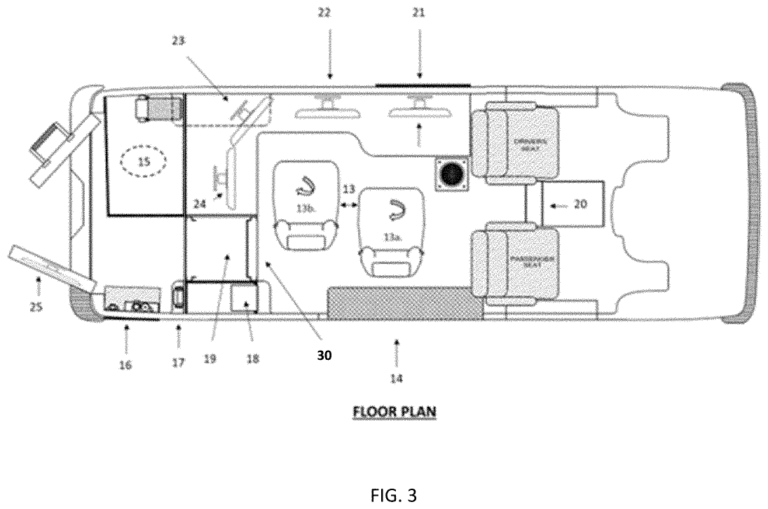

FIG. 3 illustrates the floor plan 300 of the command and control vehicle, which includes pilot cockpit and control stations, equipment rack, monitors, electrical panel and communication systems. Special consideration is given to ergonomics, work environment, flow of information, monitor orientation, and accessibility with a focus on maximizing operator performance and situational awareness. Pilots/operators occupy captain seats 13 with the ability to rotate 360 degrees ensuring comfortable access to all monitors and their respective stations 13a and 13b. Curbside windows 14 can be tinted and treated to reduce the possibility of monitor glare during daylight operation. Red LED interior lighting is utilized to reduce the adverse impacts of lighting on operators' night vision. A customized area for UAV storage is in the aft compartments 15 of the vehicle. The cockpit and pilot stations are climate controlled and can be powered from any of the available electrical systems, such as a 5 kW commercial generator, a battery charger and inverter 17, auxiliary batteries, and/or shore power 16. Circuit breakers, fuses, and electrical source switches are located in an electrical panel 18 abeam the equipment rack 19 for easy operator access.

An integrated and vertically oriented equipment rack 19 is positioned left of the operator monitor stations. The equipment rack 19 provides stable mounting and vibration resistance for the majority of IT equipment used to facilitate all UAV operating systems. Systems are fed into an 8×8 HDMI matrix, which divides video signals from all incoming aircraft and sensor data and is displayed on individual monitors 21-24 in the pilot/operator workstations and an external monitor 25. Each monitor can display various data regarding the control of a UAV. For example monitor 21 can display data from a UAV-mounted chemical and RAD sensor. Monitor 22 can display video from a UAV-mounted infrared camera. Monitor 23 can display data corresponding to flight control computer software. Monitor 24 can display aircraft position data from a radar-as-a-service service supplier. Monitor 30 can display video feed from the mast-mounted camera. Monitor 25 can display anything of this information to an outside observer.

A commercially available 4G/LTE repeater and router capable of operating at gigabit speeds are employed for LTE, WiFi, and Ethernet based systems within the equipment rack 19. The router provides advanced and reliable communications both inside and outside of the vehicle for WiFi and direct-to-cloud applications (such as user dashboard), through multiple carrier service, and roll-over capability via an auto-carrier selection switch. This optimizes the continuity of connectivity for essential functions required to safely integrate and operate into the NAS such as weather reports and flight planning, automatic dependent surveillance, radar-as-a-service, and low altitude authorization and notification capability (LAANC) systems.

A dual link ADS-B transceiver with integrated Satellite Based Augmentation System (SBAS), Global Positioning System (GPS) and precision barometric sensor is mounted and integrated on-board the UAV. The receiver for individually assigned UAVs and a web-based service that tracks and follows all other aircraft equipped with ADS-B in the area of operation is displayed in the cockpit on a monitor 23. ADS-B assists with Detect and Avoid (DAA) functionality for UAS operations in the NAS. ADS-B IN can operate on 1090 MHz and 978 MHz, whereas ADS-B OUT can operate on 978 MHz. The integrated system detects ADS-B equipped aircraft on 1090 MHz and 978 MHz within a 100-statute mile radius in real time and addresses federal regulatory concerns as well as concerns of integration as defined in the UTM Conflict Management Model of FIG. 5. Moreover, this integrated system is in compliance with other various federal regulations.

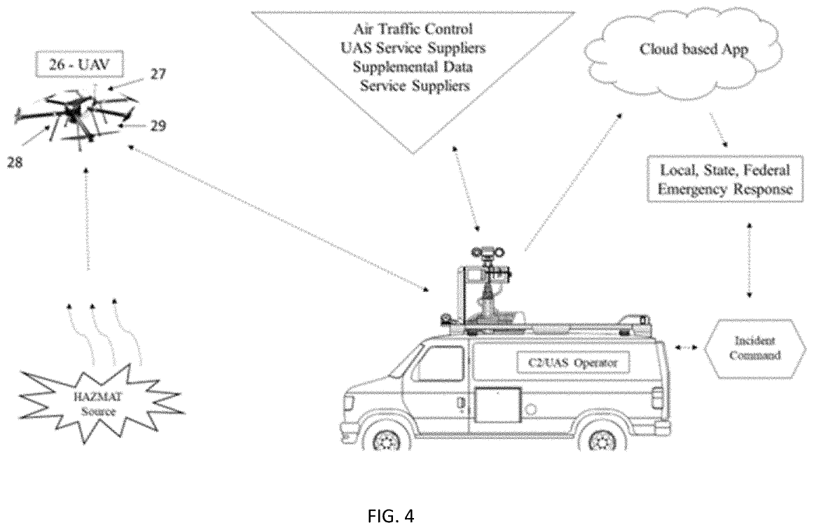

FIG. 4 illustrates an environment 400 for controlling and operating UAVs, according to an embodiment of the claimed invention. The environment 400 can include a UAV 26, an ADS-B transmitter 27, an infrared camera 28, and a chemical and RAD sensor 29.

The UAV 26 is equipped with an off the shelf infrared camera 28 for the detection of gases. A radiometric thermal camera measures the temperature of a surface by interpreting the intensity of an infrared signal. Utilizing radiometric temperature, the camera 28 can be calibrated to correlate a temperature with a certain level of radiation intensity within the spectral band of 3.2 μm-3.4 μm. Methane and other HydroCarbon gases can be detected and later confirmed with the use of other sensor technologies. Capable of capturing images or video, content is stored on an internal micro-storage device and also transmitted to the command and control vehicle 22 utilizing the 2.4 GHz radios and antennae.

The UAV 26 can be mounted with a commercially available, UAV-mounted chemical and radiation sensor 29. The sensor 29 can be integrated with a wireless controller, a sampling unit which includes sampling pump, a micro-controller, GPS, a long-range RF, a cellular modem, and on-board data storage (e.g., an SD Card). The sensor 29 can be a combination of electro-chemical sensors, non-dispersive infrared sensors, photo-ionization detection sensors, and Geiger counter (e.g., for radiation detection). Sensor data is transmitted back to the command and control vehicle via RF signal and outputs to a designated computer for further analysis and transmission. The sensor can additionally or alternatively be a chemical sensor that can detect chemical compounds such as Carbon Dioxide, Carbon Monoxide, Chlorine, Hydrogen, Hydrogen Chloride, Hydrogen Cyanide, Phosphine, Hydrogen Sulfide, Organic solvents, Methane, Nitric Oxide, Nitrogen Dioxide, Nitrous Oxide, Oxygen, VOCs, Sulfur Dioxide, Formaldehyde, Particulates, Non-methane Hydrocarbon, T R S and Amines, Ammonia, Ozone, Radiation, Chlorine Dioxide, and the like. The sensor 29 provides the command and control vehicle the ability of standoff monitoring, detection, and incident command of HAZMAT emergency response to accidents or natural disasters or possible attack.

The UAV 26 can also include an ADS-B transmitter 27 for transmitting surveillance-broadcast communications, such as to the ADS-B receiver 2 as discussed with reference to FIG. 1.

A dust and waterproof frame can be incorporated in to the UAV design to protect sensitive aircraft components such as the on-board flight computer and also to provide the capability for decontamination of TIM. Further, a mounted laser altimeter can also be incorporated into the UAV 26, which can offer hyper accurate flight control.

### Exemplary Process

The environment 400 also depicts a scenario and the processes of the command and control system for controlling and operating a specialized unmanned aerial vehicle during an emergency response event, environmental monitoring, or inspection/detection of airborne HAZMAT.

The command and control vehicle arrives at a location as requested by first responders or customers and within a safe operational stand-off distance to the potential HAZMAT source. Pilots deploy the integrated mast and utilize the mast mounted Wireless and cellular networks to acquire essential decision-making information from UAS Service Suppliers, and Supplemental Data Service providers such as updated weather, required flight planning information, and airspace clearances. Activating radar service subscriptions, ADS-B, as well as monitoring the VHF air band, allows the pilot operator to quickly gain situational awareness of additional manned and unmanned air traffic in the area of operation and assess any potential traffic conflicts. Communication with first responders and incident commanders can be quickly established and maintained on UHF radio frequencies. The first images from the mast mounted camera can also be established, assessed and transmitted if necessary, to the required parties.

Once the flight control links are established between the command and control vehicle and the UAV, the aircraft is launched and is dispatched to the suspected area of the HAZMAT source. Once over the scene, reconnaissance can be conducted immediately via on-board HD video or infrared camera. Within a short period of time (e.g., one minute), initial sensor readings from on-board Chemical or Radiological sensors are transmitted back to the command and control vehicle as detected, identified, and quantified agents. If required by the end users, sensor data can then be incorporated via an open API to model the plume and a forecast for potential contamination. On scene incident command can be alerted to this up-to-date sensor data via UHF radio or view it on the command and control exterior monitor. Plume modeling and sensor data can also be transmitted via wireless and cellular networks and viewed on a dashboard of the command structures located in state, regional, or federal emergency management facilities.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A system for controlling an unmanned aerial vehicle (UAV), comprising:
a mobile vehicle comprising at least a vehicle chassis;
a telescoping mast comprising a proximate end and a distal end, the proximate end coupled to a center portion of the mobile vehicle chassis; and
a plurality of antenna arrays coupled to the distal end of the telescoping mast, each of the antenna arrays having either different radio access technologies (RATs), different operating frequencies, or a combination thereof.

2. The system of claim 1, wherein the telescoping mast can extend to comprise a distance between the distal end and the proximate end of at least 50 feet.

3. The system of claim 1, the mobile vehicle further comprising a vehicle shell defining an occupancy cavity, wherein the proximate end passes through the occupancy cavity to couple to the mobile vehicle chassis.

4. The system of claim 1, wherein the plurality of antenna arrays comprises a 2.4 GHz radio antenna array, a 900 MHz radio antenna array, and a very high frequency (VHF) air-band antenna array.

5. The system of claim 1, further comprising:
the UAV, wherein the UAV communicates with the mobile vehicle via at least one antenna array of the plurality of antenna arrays of the telescoping mast.

6. The system of claim 5, wherein the mobile vehicle is in further communication with an air traffic control (ATC) station via at least another antenna array of the plurality of antenna arrays of the telescoping mast.

7. The system of claim 5, wherein the UAV comprises a HAZMAT UAV, wherein the HAZMAT UAV includes gaseous sensory capabilities, sensor data transmission capabilities, a waterproof airframe, a dustproof airframe, or a combination thereof.

8. The system of claim 5, wherein the communication range between the UAV and the mobile vehicle is up to 40 miles.
